(19) United States
(12) Patent Application Publication
(10) Pub. No.: US 2014/0052893 A1
(43) Pub. Date: Feb. 20, 2014

(54) FILE DELETION FOR NON-VOLATILE MEMORY

(71) Applicants: Fan Zhang, Milpitas, CA (US); Zongwang Li, Dublin, CA (US); Ming Jin, Fremont, CA (US); Erich F. Haratsch, Bethlehem, PA (US)

(72) Inventors: Fan Zhang, Milpitas, CA (US); Zongwang Li, Dublin, CA (US); Ming Jin, Fremont, CA (US); Erich F. Haratsch, Bethlehem, PA (US)

(73) Assignee: LSI CORPORATION, Milpitas, CA (US)

(21) Appl. No.: 13/585,933

(22) Filed: Aug. 15, 2012

(51) Int. Cl. G06F 12/00

(52) U.S. Cl. 711/103; 711/E12.008

(57) ABSTRACT

A device includes non-volatile memory and a controller. The controller receives a write request including data and a logical address associated with a file. The controller stores the data at a data storage segment having a physical address and associates the physical address with the logical address and a file identifier for the file. The controller receives a second write request including data and the logical address associated with the file. The controller stores the data at a second data storage segment having a second physical address and associates the second physical address with the logical address and the file identifier. When a file delete request for the file is received, the controller identifies the first physical address and the second physical address using the file identifier and erases the information stored at the first data storage segment and the second data storage segment based upon the file identification.

### BACKGROUND

The term “non-volatile memory” generally refers to computer memory configured to retain stored information even when the memory is not powered. Electrically erasable programmable read-only memory (EEPROM) is a type of non-volatile memory typically used to store small amounts of data. Flash memory refers to non-volatile computer storage that can be electrically erased and reprogrammed and is typically used to store larger amounts of data. Flash memory stores information in an array of memory cells formed using floating-gate transistors. NOR flash memory is a type of flash memory that uses floating-gate transistors connected in a configuration that resembles a NOR gate. NAND flash memory is another type of flash memory that uses floating-gate transistors connected in a configuration that resembles a NAND gate. Flash memory can be used with storage devices including removable universal serial bus (USB) storage devices (e.g., USB flash drives), memory cards, solid-state drives (SSD), and so forth.

Although flash memory can be read or programmed a byte or a word at a time in a random-access fashion, generally this type of memory can only be erased one data block at a time. Erasing a block generally sets all bits in the block to a value of “1.” Once a block has been erased, any location within that block can be programmed. However, once a bit has been set to a value of “0,” the bit-value may only be changed to a “1” by erasing the entire block. Thus, flash memory can provide random-access read and programming operations, but does not offer arbitrary random-access rewrite or erase operations. (It should be noted that a location can be “rewritten” as long as the new value's “0” bits are a superset of the overwritten values.) Flash memory generally has a finite number of program-erase (P/E) cycles. For example, some flash memory products are configured to withstand approximately one hundred thousand (100,000) P/E cycles before wear begins to deteriorate storage integrity.

Flash memory is typically used with a controller or file system that implements a block-level interface, often referred to as a flash transition layer (FTL), to perform wear leveling and error correction, e.g., to spread writes over the available storage space and prevent incremental writing within a block. For example, when flash memory is updated, a controller or file system typically writes a new copy of the changed data to a location different from where it was previously stored, remaps associated file pointers, and subsequently erases the old data, generally at a later time. This technique is designed to minimize the number of P/E cycles. For example, some chip firmware or file system drivers are configured to count writes and dynamically remap blocks in order to spread write operations between different sectors of flash memory. Additionally, in some instances, a technique such as bad block management (BBM) can be used to verify writes and remap blocks to spare sectors when write failures are detected. These techniques are designed to minimize and compensate for memory wear, extending the useable life of flash memory devices.

### SUMMARY

Techniques are described for implementing secure file-deletion in accordance with example implementations of the present disclosure. A device includes non-volatile memory configured to store information using data storage segments that are addressable via physical addresses. The device also includes a controller operatively coupled with the non-volatile memory. The controller is configured to receive a first write request associated with a file, where the first write request includes a first portion of data and a first logical address. The controller stores the first portion of data at a first data storage segment having a first physical address and associates the first physical address with both the first logical address and a file identifier for the file. The controller is configured to receive a second write request associated with the file, where the second write request includes a second portion of data and the first logical address, and where the second portion of data is different than the first portion of data. The controller stores the second portion of data at a second data storage segment having a second physical address and associates the second physical address with both the first logical address and the file identifier. The controller is configured to receive a file delete request associated with the file, identify the first physical address and the second physical address using the file identifier, and erase the information stored at the first data storage segment and the second data storage segment based upon the identification performed using the file identifier.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1A is a diagrammatic illustration of logical addresses and physical addresses associated with information stored in non-volatile memory of a solid-state drive (SSD) storage device, such as information stored in pages of NAND flash memory, where the SSD is used to store a confidential file, where a flash transition layer (FTL) interface is used to map logical addresses to corresponding physical addresses, and where the logical and physical address mapping is shown before wear leveling.

FIG. 1B is a diagrammatic illustration of the logical and physical addresses associated with the information stored in the SSD storage device illustrated in FIG. 1A, where the logical and physical address mapping is shown after wear leveling.

FIG. 2 is a diagrammatic illustration of a file ID to physical address mapping table (FPAMT) that can be implemented with an FTL to track physical addresses of files classified as confidential in accordance with example implementations of the present disclosure.

FIG. 3 is a block diagram illustrating a non-volatile memory connected to a controller for implementing secure file-deletion in accordance with example implementations of the present disclosure.

FIG. 4 is a flow diagram illustrating a method for implementing secure file-deletion in non-volatile memory in accordance with example implementations of the present disclosure.

### DETAILED DESCRIPTION

Information is typically “removed” from flash memory by marking a block as invalid. Invalid blocks can result from wear leveling, such as when data has been rewritten to a new location. Invalid blocks can also result from identifying a bad block and remapping the data to a different block (e.g., in the case of a write failure). In these instances, some or all of the data typically remains at the previous location, and may still be accessible. Traditional file sanitization techniques designed for hard disk drives (HDD) can make secure deletion of files stored in flash memory difficult. For example, techniques that attempt to securely delete information by repeatedly writing to a particular logical address are generally unsuccessful, as the data is written to a different block each time rather than overwriting the block where the data was previously stored. Further, with flash memory, it may be difficult to execute secure file deletion while leaving other files intact.

In an example NAND flash memory implementation, memory cells are organized by word-lines and bit-lines into pages, and the pages are organized into blocks. In some instances, a page may comprise between at least approximately five hundred and twelve (512) bytes and four thousand (4,000) bytes, and a block may comprise between at least approximately thirty-two (32) pages and five hundred and twelve (512) pages. During programming in some implementations, cell levels may only be increased and not decreased. Thus, to decrease the cell levels, an entire block of cells may have to be erased together (e.g., when the minimum erasure size is a block). In this configuration, the minimum read/program size is a page. An FTL can provide a software layer to separate logical addresses (e.g., for an OS) and physical addresses (e.g., for firmware and/or channel) in the flash memory.

Solid-state drive (SSD) storage devices that use non-volatile memory offer high performance, and are used by individuals, corporations, governments, and other entities who often desire protection of confidential data, such as sensitive information stored on an SSD. Thus, it is generally desirable to provide limited access to confidential data, as well as secure file deletion when the data is no longer required. However, current file deletion techniques, which are designed for hard disk drive (HDD) storage devices, may not be effective with SSD, as previously described. Further, it may be significantly easier to access information stored on an SSD (e.g., as compared to accessing data stored on an HDD). Thus, secure file deletion for SSD's can be difficult, especially when it is desired to leave other data stored on an SSD intact. For example, one technique would be to erase the entire contents of an SSD, also erasing information associated with other files stored on the SDD. Another technique would be to use cryptographic sanitization, which can be computationally demanding and may not provide full security in all instances. Another technique would be to scan an SSD and erase all pages with logical block addresses associated with a particular file. However, this will not necessarily erase all information associated with a particular file, e.g., when wear leveling is used and invalid blocks are present but no longer associated with the file.

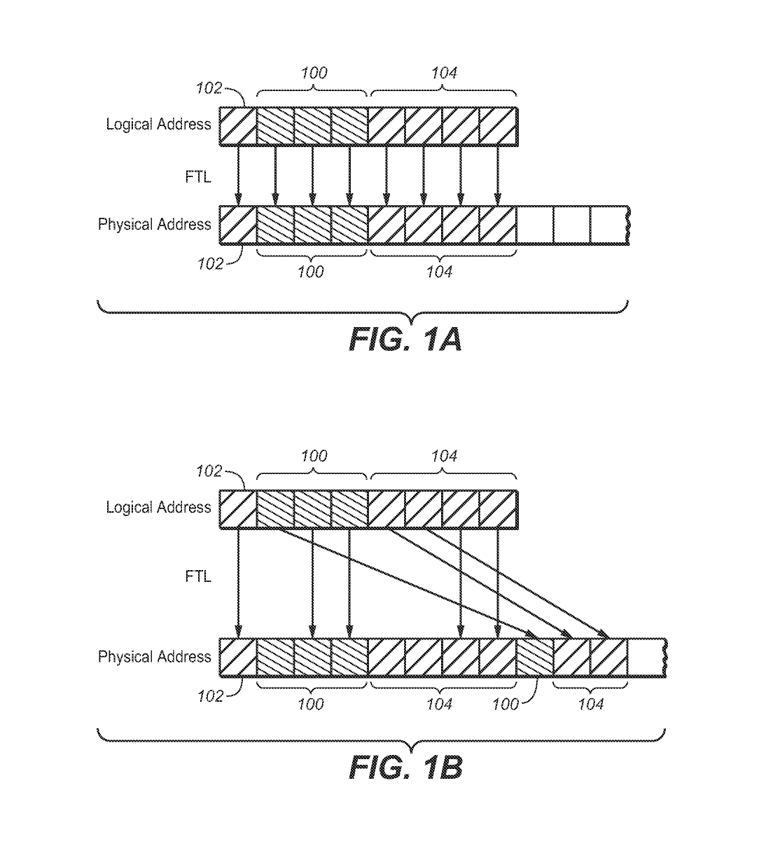

Techniques are described for implementing secure file-deletion in non-volatile memory, such as NAND flash memory. Techniques of the present disclosure can be used with various signal processing techniques, including algorithms, digital signal processing (DSP), coding, read channel techniques, and so forth. File identifier (ID)-based secure file deletion techniques are described. These techniques can be used with, for example, a NAND flash memory-based SSD device. In example instances, an FTL can be used to provide an interface that writes to a different physical address each time (e.g., to wear level a device). The FTL can maintain a mapping between a logical address and a physical address. In some instances, the address granularity can be the size of a page. However, a page is provided by way of example only and is not meant to be restrictive of the present disclosure. Thus, in other implementations, the address granularity can be the size of a block. With reference to FIGS. 1A and 1B, confidential information 100 associated with a confidential file stored in an SSD may be stored along with information 102 and 104 associated with two other files, as described in FIG. 1A. After wear leveling, the confidential information may span multiple pages, some of which may no longer be associated with the logical addresses of the confidential file, as described in FIG. 1B.

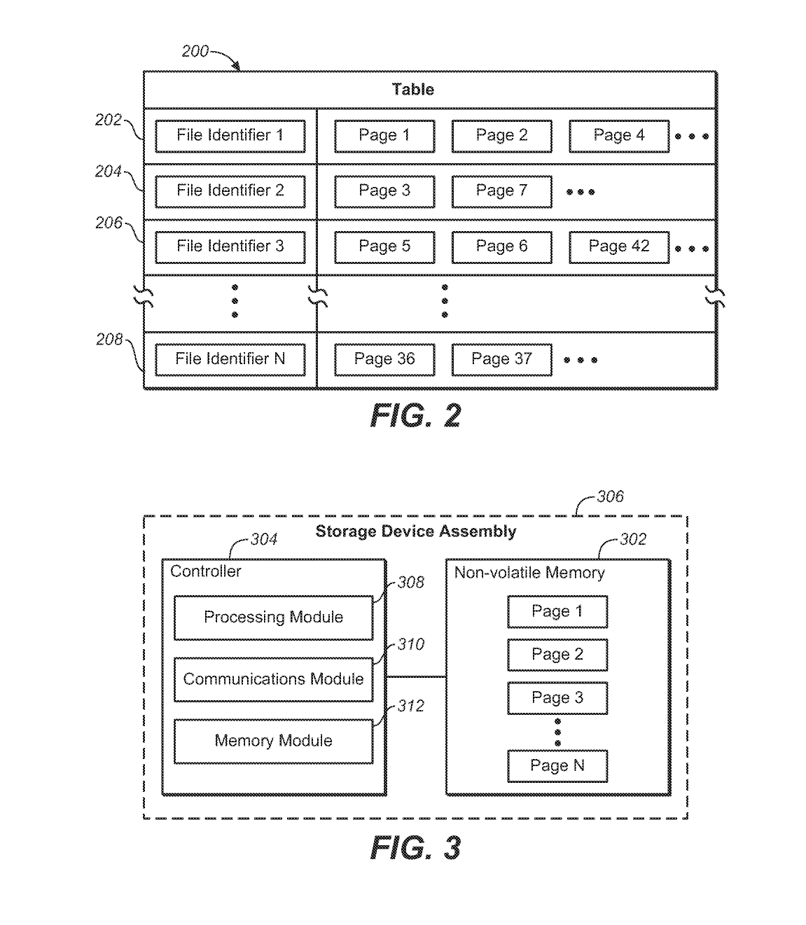

Referring now to FIG. 2, a file ID to physical address mapping table (FPAMT) 200 can be implemented with, for instance, an FTL to track physical addresses of files classified as confidential, such as confidential information 100 illustrated in FIGS. 1A and 1B. In implementations, a file can be identified as confidential by an OS, a user, a connected device, and so forth. In some instances, all files can be identified as confidential. In other instances, the techniques of the present disclosure can be used with files that may not necessarily be identified as confidential. For example, the physical addresses of various files in a non-volatile memory not identified as confidential can be tracked using an FTL, and secure file-deletion can be implemented for the files. In the example table 200, rows 202, 204, 206, and 208 correspond to different file IDs. Columns in the table 200 are used for the physical addresses that portions of the confidential file are stored in, as well as the physical addresses that portions of the confidential file were stored in (e.g., pages associated with invalid blocks, and so forth).

After wear leveling, error correction, file creation, and so forth, new entries are inserted into the table in the row of a particular file. Then, when a confidential file is deleted, the corresponding row can be removed from the table 200. When a new confidential file is created, a new row can be inserted into the table 200. In implementations, when a confidential file is deleted, the file is located in the FPAMT, and the pages associated with that file are programmed to a value of “0.” However, table 200 and its associated structure, including rows 202, 204, 206, and 208, columns, and so forth, are provided by way of example only and are not meant to be restrictive of the present disclosure. Thus, other data structures can be used, such as a table where the columns correspond to file IDs, rows correspond to physical addresses, and so forth.

Referring now to FIG. 3, non-volatile memory 302 may be configured to connect to one or more controllers 304, which may comprise, for example, a separate controller chip; a file system; device driver software, firmware, and/or hardware; a device file; and so forth. For example, a controller 304 may be implemented as a control chip for a storage device assembly 306 (e.g., a USB storage device) that employs non-volatile memory 302. Additionally, a controller 304 may be implemented as a memory technology device (MTD) file configured to allow an operating system (OS) to interact with non-volatile memory 302, such as Flash-EEPROM. In this configuration, an MTD file can furnish a layer of abstraction between, for instance, hardware-specific device drivers for the non-volatile memory 302 and higher-level applications executed via an OS. In other implementations, one or more controllers 304 may be included with circuitry of the non-volatile memory 302. For example, a controller 304 may be implemented as controller circuitry for a memory card device that employs non-volatile memory 302. In these various configurations, the controller 304 can be configured to implement a block-level interface, such as a flash transition layer (FTL), which can perform wear leveling and error correction (e.g., as previously described).

As illustrated in FIG. 3, the non-volatile memory 302 may be coupled with the controller 304 for controlling the non-volatile memory 302. The controller 304 may include a processing module 308, a communications module 310, and a memory module 312. The processing module 308 provides processing functionality for the controller 304 and may include any number of processors, micro-controllers, or other processing systems and resident or external memory for storing data and other information accessed or generated by the controller 304. The processing module 308 may execute one or more software programs, which implement techniques described herein. The processing module 308 is not limited by the materials from which it is formed or the processing mechanisms employed therein, and as such, may be implemented via semiconductor(s) and/or transistors (e.g., using electronic integrated circuit (IC) components), and so forth. The communications module 310 is operatively configured to communicate with components of the non-volatile memory 302. For example, the communications module 310 can be configured to transmit data for storage in the non-volatile memory 302, retrieve data from storage in the non-volatile memory 302, and so forth. The communications module 310 is also communicatively coupled with the processing module 308 (e.g., to facilitate data transfer between the non-volatile memory 302 and the processing module 308).

The memory module 312 is an example of tangible computer-readable media that provides storage functionality to store various data associated with operation of the controller 304, such as software programs and/or code segments, or other data to instruct the processing module 308 and possibly other components of the controller 304 to perform the steps described herein. For example, memory module 312 may be used to store one or more tables, (e.g., table 200 described in FIG. 2), comprising file identifiers and associated physical addresses. Although a single memory module 312 is shown, a wide variety of types and combinations of memory may be employed. The memory module 312 may be integral with the processing module 308, may comprise stand-alone memory, or may be a combination of both. The memory module 312 may include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, USB memory devices, and so forth. In embodiments, the controller 304 and/or memory module 312 may include removable integrated circuit card (ICC) memory, such as memory provided by a subscriber identity module (SIM) card, a universal subscriber identity module (USIM) card, a universal integrated circuit card (UICC), and so on.

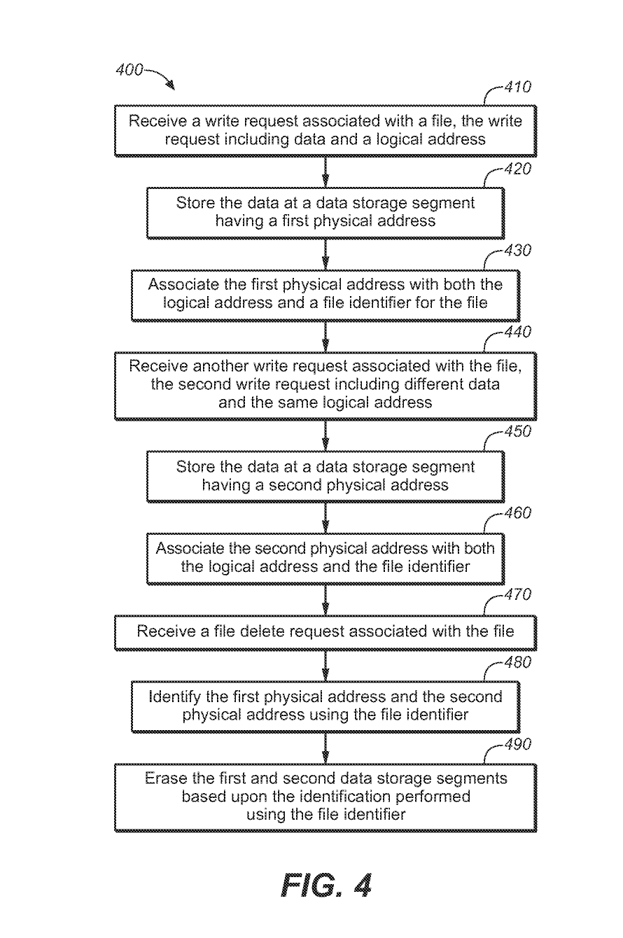

Referring now to FIG. 4, example techniques are described for erasing a file stored in non-volatile memory. FIG. 4 depicts a process 400, in an example implementation, for erasing a file stored in non-volatile memory, such as the non-volatile memory 302 illustrated in FIG. 3 and described above.

In the process 400 illustrated, a write request associated with a file is received. The write request includes data and a logical address (Block 410). For example, with reference to FIG. 3, the controller 304 can receive a request to store a first portion of data (e.g., a first page of data, a first block of data, and so forth) in the non-volatile memory 302 at a logical address. The request can be supplied from, for example, an OS executing on a computer connected to the controller 304. The first portion of data is associated with a particular file, such as a file stored by the OS using the non-volatile memory 302. In implementations, the OS can provide an identification of the file to the controller 304, e.g., as part of a file system protocol. Then, the data is stored at a data storage segment having a first physical address (Block 420). For example, with continuing reference to FIG. 3, the controller 304 can initiate storage of the first portion of data at a storage location in the non-volatile memory 302 having a first physical address (e.g., a data storage page, a data storage block, and so forth). Next, the first physical address is associated with both the logical address and a file identifier for the file (Block 430). For instance, with reference to FIG. 2, the physical address of the storage location storing the first portion of data can be stored in the table 200 and associated with a file identifier for the file.

Then, another write request associated with a file is received. The second write request includes different data and the same logical address (Block 440). For example, with reference to FIG. 3, the controller 304 can receive a second request to store a different portion of data in the non-volatile memory 302 at the same logical address. The second write request can be the result of, for instance, an update where a copy of changed data is written to a new location different from where it was previously stored (e.g., when wear leveling is used with the non-volatile memory 302). Next, the data is stored at a data storage segment having a second physical address (Block 450). For example, with continuing reference to FIG. 3, the controller 304 can initiate storage of the second portion of data at a storage location in the non-volatile memory 302 having a second physical address different than the first physical address (e.g., a second data storage page, a second data storage block, and so forth). Then, the second physical address is associated with both the logical address and a file identifier for the file (Block 460). For instance, with reference to FIG. 2, the physical address of the storage location storing the second portion of data can be stored in the table 200 and associated with the file identifier for the file.

Next, a file delete request associated with the file is received (Block 470). For example, with reference to FIG. 3, the controller 304 can receive a request to delete the file associated with the second portion of data. The request can be supplied from, for example, an OS executing on a computer connected to the controller 304 (e.g., as previously described), and the OS can provide an identification of the file to the controller 304, e.g., as part of a file system protocol. Then, the first physical address and the second physical address can be identified using the file identifier (Block 480). For example, with continuing reference to FIGS. 2 and 3, the controller 304 can examine the table 200 and use a file identifier associated with a file to identify various physical addresses where information associated with a particular file is stored. Next, the first data storage segment and the second data storage segment (and other data segments associated with a file) are erased based upon the identification performed using the file identifier (Block 490). For example, with NAND flash memory, pages associated with the file can be zeroed (e.g., programmed to a value of “0”).

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A device comprising:
a non-volatile memory configured to store information using a plurality of data storage segments, each one of the plurality of data storage segments addressable via an associated physical address; and
a controller operatively coupled with the non-volatile memory, the controller configured to receive a first write request associated with a file, the first write request including a first portion of data and a first logical address, the controller configured to store the first portion of data at a first data storage segment having a first physical address and associate the first physical address with both the first logical address and a file identifier for the file, the controller configured to receive a second write request associated with the file, the second write request including a second portion of data and the first logical address, the second portion of data different than the first portion of data, the controller configured to store the second portion of data at a second data storage segment having a second physical address and associate the second physical address with both the first logical address and the file identifier, the controller configured to receive a file delete request associated with the file, identify the first physical address and the second physical address using the file identifier, and erase the information stored at the first data storage segment and the second data storage segment based upon the identification performed using the file identifier.

2. The device as recited in claim 1, wherein the non-volatile memory comprises at least one of NOR flash memory or NAND flash memory.

3. The device as recited in claim 1, wherein the first physical address is different from the second physical address to wear level the non-volatile memory.

4. The device as recited in claim 1, wherein the file comprises a confidential file.

5. The device as recited in claim 1, wherein the first physical address, the second physical address, and the file identifier are stored in a table by the controller, and the first physical address and the second physical address are stored in a row in the table associated with the file identifier.

6. The device as recited in claim 5, wherein the row in the table associated with the file identifier is deleted after the information stored at the first data storage segment and the second data storage segment is erased.

7. The device as recited in claim 1, wherein erasing the information stored at the first data storage segment and the second data storage segment comprises zeroing the first data storage segment and the second data storage segment.

8. A method comprising:
receiving a first write request associated with a file, the first write request including a first portion of data and a first logical address;
storing the first portion of data at a first data storage segment having a first physical address;
associating the first physical address with both the first logical address and a file identifier for the file;
receiving a second write request associated with the file, the second write request including a second portion of data and the first logical address, the second portion of data different than the first portion of data;
storing the second portion of data at a second data storage segment having a second physical address;
associating the second physical address with both the first logical address and the file identifier;
receiving a file delete request associated with the file;
identifying the first physical address and the second physical address using the file identifier; and
erasing the information stored at the first data storage segment and the second data storage segment based upon the identification performed using the file identifier.

9. The method as recited in claim 8, wherein the first physical address is different from the second physical address to wear level the non-volatile memory.

10. The method as recited in claim 8, wherein the file comprises a confidential file.

11. The method as recited in claim 8, further comprising storing the first physical address and the second physical address in a row in a table associated with the file identifier.

12. The method as recited in claim 11, further comprising deleting the row in the table associated with the file identifier after the information stored at the first data storage segment and the second data storage segment is erased.

13. The method as recited in claim 8, wherein erasing the information stored at the first data storage segment and the second data storage segment comprises zeroing the first data storage segment and the second data storage segment.

14. A system comprising:
a control module for operatively coupling with a non-volatile memory, the non-volatile memory configured to store information using a plurality of data storage segments, each one of the plurality of data storage segments addressable by the control module via an associated physical address; and
control programming configured to instruct the control module to:
receive a first write request associated with a file, the first write request including a first portion of data and a first logical address;
store the first portion of data at a first data storage segment having a first physical address;
associate the first physical address with both the first logical address and a file identifier for the file;
receive a second write request associated with the file, the second write request including a second portion of data and the first logical address, the second portion of data different than the first portion of data;
store the second portion of data at a second data storage segment having a second physical address;
associate the second physical address with both the first logical address and the file identifier;
receive a file delete request associated with the file;
identify the first physical address and the second physical address using the file identifier; and
erase the information stored at the first data storage segment and the second data storage segment based upon the identification performed using the file identifier.

15. The system as recited in claim 14, wherein the non-volatile memory comprises at least one of NOR flash memory or NAND flash memory.

16. The system as recited in claim 14, wherein the first physical address is different from the second physical address to wear level the non-volatile memory.

17. The system as recited in claim 14, wherein the file comprises a confidential file.

18. The system as recited in claim 14, wherein the first physical address, the second physical address, and the file identifier are stored in a table by the controller, and the first physical address and the second physical address are stored in a row in the table associated with the file identifier.

19. The system as recited in claim 18, wherein the row in the table associated with the file identifier is deleted after the information stored at the first data storage segment and the second data storage segment is erased.

20. The system as recited in claim 14, wherein erasing the information stored at the first data storage segment and the second data storage segment comprises zeroing the first data storage segment and the second data storage segment.
